(19) United States
(12) Patent Application Publication
(10) Pub. No.: US 2020/0029068 A1
(43) Pub. Date: Jan. 23, 2020

(54) METHOD AND APPARATUS FOR DUAL-SCREEN DISPLAY, VIDEO GLASSES, CHIP AND PROCESSOR

(71) Applicant: SZ DJI TECHNOLOGY CO., LTD., Shenzhen (CN)

(72) Inventors: Huaiyu LIU, Shenzhen (CN); Qing ZHU, Shenzhen (CN)

(21) Appl. No.: 16/585,710

(22) Filed: Sep. 27, 2019

Related U.S. Application Data
(63) Continuation of application No. PCT/CN2017/078986, filed on Mar. 31, 2017.

(51) Int. Cl. H04N 13/398; H04N 13/344; H04N 13/194; H04N 13/156; H04N 13/161; H04N 13/167; H04N 13/356; H04N 13/139

(52) U.S. Cl. CPC H04N 13/398; H04N 13/344; H04N 13/194; H04N 13/139; H04N 13/161; H04N 13/167; H04N 13/356; H04N 13/156

(57) ABSTRACT

The present disclosure provides a pair of video glasses. The video glasses include a body, and an application processor, a dual-screen driver chip, a first screen, and a second screen carried on the body. The application processor transmits an image to be displayed to the dual-screen driver chip; the dual-screen driver chip performs a dual-screen display processing on the received image to be displayed to obtain a first image to be displayed on the first screen and a second image to be displayed on the second screen, and transmits the first image to the first screen and the second image to the second screen; the first screen displays the first image; and, the second screen displays the second image.

### CROSS-REFERENCE TO RELATED APPLICATION

This application is a continuation application of International Application No. PCT/CN2017/078986, filed on Mar. 31, 2017, the entire contents of which is incorporated herein by reference.

### TECHNICAL FIELD

The present disclosure relates to the field of image processing technology, more specifically, to a method and apparatus for a dual-screen display, a pair of video glasses, a chip, and a processor.

### BACKGROUND

Display devices such as head-mounted display devices (commonly referred to as head-mounted displays) can achieve various visual effects such as Virtual Reality (VR), Augmented Reality (AR), and Mixed Reality (MR) by transmitting optical signal to the eyes.

With the increased demand for better display effects, the demand for dual-screen display devices has increased as well. The principle of a dual-screen display device is to drive two high resolution (such as 2048×2048) screens of the dual-screen display device to display to the left eye and the right eye, respectively. This allows the display of different contents as well as provides a higher monocular resolution for a clearer display.

However, in a dual-screen display device, the two high resolution (such as 2048×2048) screens on the dual-screen display device need to be driven to display to the left eye and the right eye, respectively, and the performance requirement of the processor in the dual-screen display device is very high. Often, the performance of the application processor in the dual-screen display device is insufficient to simultaneously drive the two screens of the dual-screen display device, which prevents the implementation of the dual-screen display.

### SUMMARY

The present disclosure provides a method and apparatus for a dual-screen display, a pair of video glasses, a chip, and a processor to achieve low-cost dual-screen display.

One aspect of the present disclosure provides a pair of video glasses. The video glasses include a body, and an application processor, a dual-screen driver chip, a first screen, and a second screen carried on the body. The application processor transmits an image to be displayed to the dual-screen driver chip; the dual-screen driver chip performs a dual-screen display processing on the received image to be displayed to obtain a first image to be displayed on the first screen and a second image to be displayed on the second screen, and transmits the first image to the first screen and the second image to the second screen; the first screen displays the first image; and, the second screen displays the second image.

Another aspect of the present disclosure provides a dual-screen driver chip. The chip includes a first interface, two second interfaces, and a dual-screen driving module. The first interface receives an image to be displayed; one of the two second interfaces is connected to a first screen of a dual-screen display device, and the other second interfaces is connected to a second screen of the dual-screen display device; and, the dual-screen driving module performs a dual-screen display processing on the image to be displayed received through the first interface to obtain a first image to be displayed on the first screen and a second image to be displayed on the second screen, and transmit the first image to the first screen through the second interface connected to the first screen and the second image to the second screen through the second interface connected to the second screen.

Another aspect of the present disclosure provides a processor. The processor includes an interface, an acquisition module, and a transmission module. The interface is connected to a dual-screen driver chip; the acquisition module acquires an image to be displayed; the transmission module unicasts the image to be displayed acquired by the acquisition module by using the interface.

As can be seen from the above, in embodiments of the present disclosure, the application processor is only responsible for outputting the image to be displayed to the dual-screen driver chip and does not drive the dual-screen (e.g., the first screen and the second screen) to display images, which greatly reduces the performance requirements of the application processor.

In addition, in the present disclosure, a hardware chip (e.g., the dual-screen driver chip) is used to drive the dual-screen (e.g., the first screen and the second screen) to display images instead of the application processor, which can provide a low cost dual-screen display on one hand and enhance the image clarity of the dual-screen images on the other hand.

### BRIEF DESCRIPTION OF THE DRAWINGS

To describe the technical solutions of the embodiments of the present disclosure more clearly, the following briefly introduces the accompanying drawings used in the description of the embodiments of the present disclosure. Apparently, the accompanying drawings described below illustrate only some exemplary embodiments of the present disclosure, and persons skilled in the art may derive other drawings from the drawings without making creative efforts.

FIG. 1 is schematic diagram of a dual-screen display device according to an embodiment of the present disclosure;

FIG. 2 is a schematic view illustrating the application of a first embodiment of the present disclosure;

FIG. 3 is a schematic diagram of a network application in a first embodiment of the present disclosure;

FIG. 4 is a schematic diagram illustrating the application of a second embodiment of the present disclosure;

FIG. 5a is a schematic diagram of a network application of a second embodiment of the present disclosure;

FIG. 5b is a schematic diagram of another network application of a second embodiment of the present disclosure;

FIG. 6 is a schematic diagram of the application of a third embodiment of the present disclosure;

FIG. 7 is schematic diagram of a pair of video glasses according to an embodiment of the present disclosure;

FIG. 8 is a schematic diagram of a dual-screen driver chip 102 according to an embodiment of the present disclosure;

FIG. 9a is a schematic diagram of a dual-screen driver chip 102 connected to an application processor 101 through a first interface according to an embodiment of the present disclosure;

FIG. 9b is a schematic diagram of a dual-screen driver chip 102 connected to an external device processor 101 through a first interface according to an embodiment of the present disclosure;

FIG. 9c is a schematic diagram of a dual-screen driver chip 102 connected to an external device processor 101 through a first interface and an interface bridging chip according to an embodiment of the present disclosure;

FIG. 10 is a schematic diagram of an application processor 101 according to an embodiment of the present disclosure;

FIG. 11 is a flowchart of a method according to an embodiment of the present disclosure; and

FIG. 12 is a schematic diagram of a device according to an embodiment of the present disclosure.

### DETAILED DESCRIPTION OF THE EMBODIMENTS

The technical solutions according to the embodiments of the present disclosure will be clearly and fully described hereinafter in conjunction with the accompanying drawings in the embodiments of the present disclosure. Obviously, the described embodiments are merely parts of embodiments of the present disclosure, but not all the embodiments. Based on the embodiments in the present disclosure, all the other embodiments obtained by a person skilled in the art will fall within the protection scope of the present disclosure. In addition, the features of the embodiments described below may be combined with each other when there is no conflict.

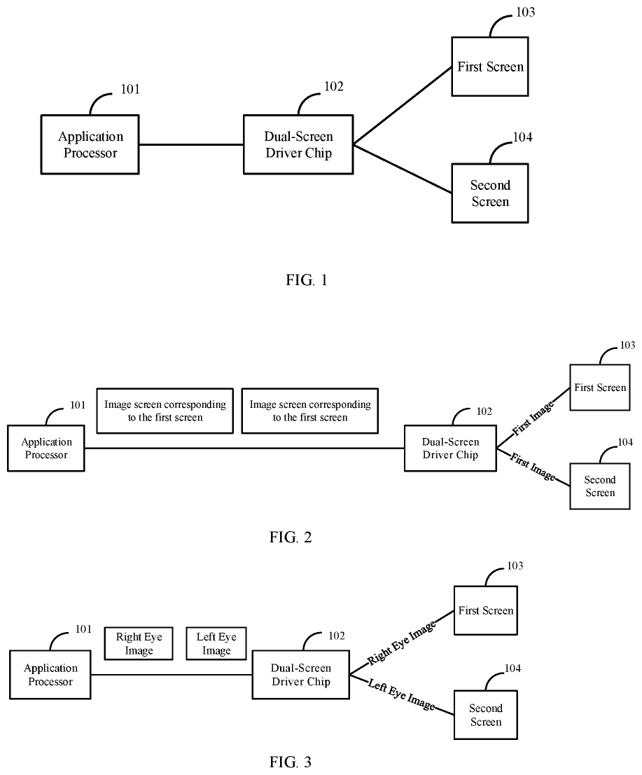

Referring to FIG. 1, which is a structural diagram of a dual-screen display device according to an embodiment of the present. As shown in FIG. 1, the dual-screen display device may include an application processor 101, a dual-screen driver chip 102, a first screen 103, and a second screen 104.

The application processor 101 may be used to transmit an image to be displayed to the dual-screen driver chip 102. As can be seen from the structure shown in FIG. 1, in the present disclosure, the application processor 101 may only unicast one image to be displayed to the dual-screen driver chip 102 and may not be used to drive the dual-screen, for example, the first screen 103 and the second screen 104. Therefore, in the present disclosure, the application processor 101 may not be required to have high performance and a low to mid-range application processor currently available may be sufficient to out the image to be displayed to the dual-screen driver chip.

The dual-screen driver chip 102 may be used to perform a dual-screen display processing on the received image to be displayed to obtain a first image that may need to be displayed on the first screen 103 and a second image that may need to be displayed on the second screen 104, and transmit the first image to the first screen 103 and the second image to the second screen 104. In one embodiment of the present disclosure, the dual-screen driver chip 102 may be an Application Specific Integrated Circuit (ASIC) chip, a Field-Programmable Gate Array (FPGA), or a Complex Programmable Logic Device (CPLD), etc., which is not specifically limited in the present disclosure.

The first screen 103 may be used to display the first image.

The second screen 104 may be used to display the second image.

It can be seen that in the present disclosure, the first image may be transmitted to the first screen 102 by the dual-screen driver chip 102 to display the first image on the first screen 103, and the second image may be transmitted to the second screen 103 by the dual-screen driver chip 102 to display the second image on the second screen 104. As such, the dual-screen driver chip 102 may drive the dual-screen display.

As can be seen from FIG. 1, in the present disclosure, the application processor is only responsible for outputting the image to be displayed to the dual-screen driver chip and does not drive the dual-screen (e.g., the first screen and the second screen) to display image, which greatly reduces the performance requirements of the application processor.

In addition, in the present disclosure, a hardware chip (e.g., the dual-screen driver chip) is used to drive the dual-screen (e.g., the first screen and the second screen) to display image instead of the application processor, which can provide a low cost dual-screen display on one hand and enhance the image clarity of the dual-screen on the other hand.

In the present disclosure, the dual-screen display device shown in FIG. 1 may supports both two-dimensional display and three-dimensional display.

The following embodiments describe how the dual-screen driver chip 102 may perform dual-screen display processing to obtain the first image and the second image when the video glasses support three-dimensional display.

### First Embodiment

In the first embodiment, the application processor 101 may transmit an image to be displayed to the dual-screen driver chip 102. In particular, the application processor 101 transmitting the image to be displayed may be: the application processor 101 transmits a screen image corresponding to the first screen and a screen image corresponding to the second screen to the dual screen driver chip 102 in sequence. The image to be displayed may be dynamically generated by the application processor 101 or may be obtained by the application processor 101 acquiring an image of the external device, which is not specifically limited by the present disclosure. FIG. 2 is a schematic diagram illustrating the application of the embodiment in which the application processor 101 first transmits the screen image corresponding to the first screen, then transmits the screen image corresponding to the second screen.

Based on the above description, in the first embodiment, after receiving the screen image corresponding to the first screen and the screen image corresponding to the second screen transmitted by the application processor 101 in sequence, the dual-screen driver chip 102 may take the received screen image corresponding to the first screen as the first image that may need to be displayed on the first screen 103 and the received screen image corresponding to the second screen as the second image that may need to be displayed on the second screen 104. At this point, the dual-screen driver chip 102 may obtain the first image that needs to be display on the first screen 103 and the second image that needs to be displayed on the second screen 104. Subsequently, the dual-screen driver chip 102 may transmit the first image to the first screen 103 and the second image to the second screen 104, thereby implementing the dual-screen display.

FIG. 3 is a schematic diagram illustrating an application of the first embodiment in which the image corresponding to the first screen may be a left eye image, and the image corresponding to the second screen may be a right eye image.

It should be noted that in the present disclosure, the dual-screen driver chip 102 may only drive the dual-screen display after receiving the screen image corresponding to the first screen and the screen image corresponding to the second screen. In the first embodiment, since the application processor 101 sequentially transmits the screen image corresponding to the first screen and the screen image corresponding to the second screen to the dual-screen driver chip 102, the dual-screen driver chip 102 may not simultaneously receive the screen image corresponding to the first screen and the screen image corresponding to the second screen. Therefore, it may be necessary to introduce a frame buffer (e.g., buffering the screen image received, such as the screen image corresponding to the first screen or the screen image corresponding to the second screen). However, the image quality displayed on the first screen and the second screen will be high.

### Second Embodiment

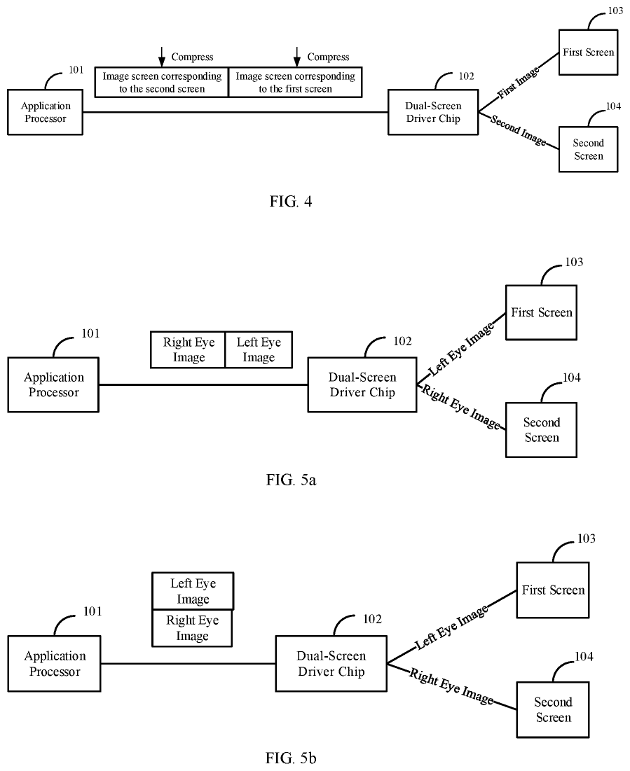

FIG. 4 is a schematic diagram illustrating the application of a second embodiment of the present disclosure.

In the second embodiment, the application processor 101 may transmit an image to be displayed to the dual-screen driver chip 102. In particular, the application processor 101 transmitting the image to be displayed may be: the application processor 101 compresses the screen image corresponding to the first screen in the image to be displayed by half along a specific direction to obtain a first screen image, and compresses the screen image corresponding to the second screen in the image to be displayed by half along the specific direction to obtain a second screen image; and the application processor 101 updates the image obtained by stitching the first screen image and the second screen image together as the image to be displayed and transmits the image to the dual-screen driver chip 102. In one embodiment, the image to be displayed transmitted by the application processor 101 to the dual-screen driver chip 102 may be composed of the first screen image and the second screen image mentioned above being stitched together along a specific direction.

Based on the above description, in the second embodiment, after receiving the image to be displayed, the dual-screen driver chip 102 may determine the specific direction along which the application processor 101 may perform the compression mentioned above, upsampling the first screen image in the received image to be displayed along the determined specific direction to obtain the first image that may need to be displayed on the first screen, and upsampling the second screen image in the received image to be displayed along the determined specific direction to obtain the second image that may need to be displayed on the first screen. At this point, the dual-screen driver chip 102 may obtain the first image that needs to be display on the first screen 103 and the second image that needs to be displayed on the second screen 104. Subsequently, the dual-screen driver chip 102 may transmit the first image to the first screen 103 and the second image to the second screen 104, thereby implementing the dual-screen display.

In one embodiment, to ensure the dual-screen driver chip 102 determines the specific direction, the application processor 101 may add the identifier of the specific direction to the image to be displayed before transmitting the image to be displayed. Subsequently, the application processor 101 may transmit the image to be displayed with the added identifier of the specific direction to the dual-screen driver chip 102.

Based on the above description, the dual-screen driver chip 102 may determine the specific direction based on the specific direction identifier carried by the image to be displayed.

In the second embodiment, the purpose of the dual-screen driver chip 102 upsampling the first screen image in the image to be displayed along the specific direction may be to restore the image of the first screen image before it is compressed by the application processor 101. Similarly, the purpose of the dual-screen driver chip 102 upsampling the second screen image in the image to be displayed along the specific direction may be to restore the screen image of the second image before it is compressed by the application processor 101.

In one embodiment, the image to be displayed transmitted by the application processor 101 to the dual-screen driver chip 102 may be composed of the first screen image and second screen image mentioned above being stitched together along a specific direction. Based on the above description, in one embodiment, the dual-screen driver chip 102 performing the upsampling on the first screen image in the image to be displayed along the specific direction in the second embodiment to obtain the first image that may need to be displayed on the first screen may be: the dual-screen driver chip 102 doubles the first screen image in the image to be displayed along the specific direction and the doubled image may serve as the first image to be displayed on the first screen. Similarly, the dual-screen driver chip 102 performing the upsampling on the second screen image in the image to be displayed along the specific direction in the second embodiment to obtain the second image that may need to be displayed on the second screen may be: the dual-screen driver chip 102 doubles the second screen image in the image to be displayed along the specific direction and the doubled image may serve as the second image to be displayed on the second screen.

In practice, the specific direction may be horizontal or vertical.

FIG. 5a illustrates the application diagram of the second embodiment in which the first screen may be the left eye screen, the second screen may be the right eye screen, and the specific direction may be the horizontal direction. As shown in FIG. 5a, the application processor 101 may compress the left eye screen image in the image to be displayed by half in the horizontal direction to obtain a left eye image and compress right left eye screen image in the image to be displayed by half in the horizontal direction to obtain a right eye image, and the application processor 101 may stitch the left eye image and the right eye image together along the horizontal direction as the image to be displayed and transmit it to the dual-screen driver chip 102. After receiving the image to be displayed, the dual-screen driver chip 102 may double the left eye image in the image to be displayed in the horizontal direction and the doubled image may serve as the first image to be displayed on the first screen. The dual-screen driver chip 102 may further double the right eye image in the image to be displayed in the horizontal direction and the doubled image may serve as the second image to be displayed on the second screen. Subsequently, the dual-screen driver chip 102 may transmit the first image to the first screen 103 for display and transmit the second image to the second screen 104 for display. As such, a low-latency dual-screen display can be achieved through FIG. 5a.

FIG. 5b illustrates another application diagram of the second embodiment in which the first screen may be the left eye screen, the second screen may be the right eye screen, and the specific direction may be the vertical direction. As shown in FIG. 5b, the application processor 101 may compress the left eye screen image in the image to be displayed by half in the vertical direction to obtain a left eye image and compress right left eye screen image in the image to be displayed by half in the vertical direction to obtain a right eye image, and the application processor 101 may stitch the left eye image and the right eye image together along the vertical direction as the image to be displayed and transmit it to the dual-screen driver chip 102. After receiving the image to be displayed, the dual-screen driver chip 102 may double the left eye image in the image to be displayed in the vertical direction and the doubled image may serve as the first image to be displayed on the first screen. The dual-screen driver chip 102 may further double the right eye image in the image to be displayed in the vertical direction and the doubled image may serve as the second image to be displayed on the second screen. Subsequently, the dual-screen driver chip 102 may transmit the first image to the first screen 103 for display and transmit the second image to the second screen 104 for display. It should be noted that when the left eye image and the right eye image in the image to be displayed are stitched together along the vertical direction, the left eye image and the right eye image in the image to be displayed may not arrive at the dual-screen driver chip 102 synchronously. At this point, a half frame buffer (to buffer the left eye image or the right eye image first received in the image to be displayed) may be introduced.

It should be noted that in the second embodiment mentioned above, if the image to be displayed does not carry the specific direction identifier, or the image to be displayed carries the specific direction identifier, but the dual-screen driver chip 102 does not recognize the specific direction identifier carried by the image to be displayed, then the dual-screen driver chip 102 may not determine the specific direction.

In one embodiment, when the dual-screen driver chip 102 is unable to determine the specific direction, the first screen image in the image to be displayed may be forcibly upsampled along the positional arrangement direction of the first screen and the second screen to obtain the first image that may need to be displayed on the first screen. The second screen image in the image to be displayed may be forcibly upsampled along the positional arrangement direction of the first screen and the second screen to obtain the second image that may need to be displayed on the second screen. Further, the first image may be transmitted to the first screen 103 and the second image may be transmitted to the second screen 104. The forcible upsampling of the first screen image and the second screen image along the positional arrangement direction of the first screen and the second screen may be similar to the upsampling process mentioned above, and details are not described herein again.

The above embodiments describe the process to implement a dual-screen display when the dual-screen display device supports three-dimensional display.

The following embodiments describe the process to implement a dual-screen display when the dual-screen display device supports two-dimensional display.

### Third Embodiment

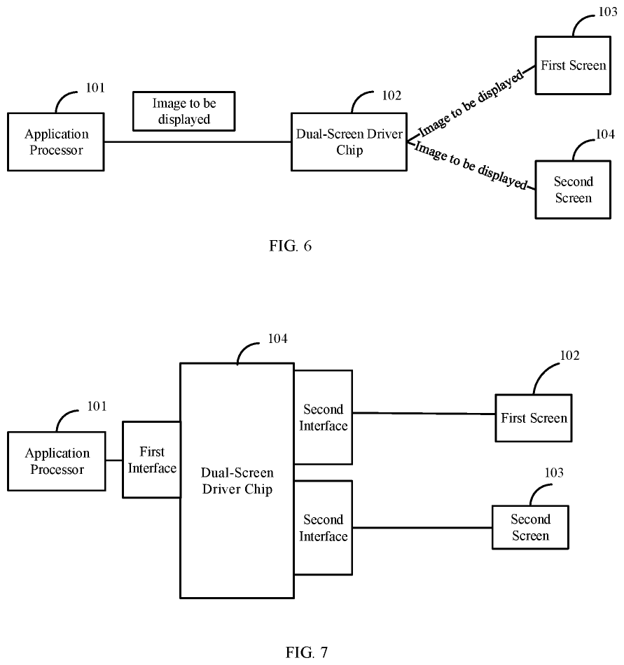

Referring to FIG. 6, which is a schematic diagram of the application of the third embodiment of the present disclosure. As shown in FIG. 6, the application processor 101 may only unicast the image to be displayed to the dual-screen driver chip 102. The image to be displayed here may be dynamically generated by the application processor 101, or it may be obtained by the application processor 101 acquiring an image of an external device, which is not specifically limited by the present disclosure.

After the dual-screen driver chip 102 receives the image to be displayed transmitted by the application processor 101, the dual-screen driver chip 102 may determine the image to be displayed as a first image to be displayed on the first screen and a second image to be displayed on the second screen, respectively. The dual screen driver chip 102 may then transmit the first the first image to the first screen 103 and the second image to the second screen 104, thereby implementing the dual-screen display.

In particular, the process mentioned the third embodiment does not introduce an addition delay, thereby achieving a low-latency dual-screen display.

The following description describes the corresponding structure of the dual-screen display device shown in FIG. 1 as a pair of video glasses.

Referring to FIG. 7, which is a structural diagram of a pair of video glasses according to an embodiment of the present disclosure. As shown in FIG. 7, the video glasses may include: a body 100, and an application processor 101, a dual-screen driver chip 102, a first screen 103, and a second screen 104 carried on the body 100. It should be noted that the application processor 101 and the dual-screen driver chip 102 may be carried on a circuit board in the body 100, and the first screen 103 and the second screen 104 may be respectively carried on the left and right lenses of the body 100.

In the present disclosure, the application processor 101 may be used to transmit an image to be displayed to the dual-screen driver chip 102.

The dual-screen driver chip 102 may be used to perform a dual-screen display processing on the received image to be displayed to obtain a first image that may need to be displayed on the first screen 103 and a second image that may need to be displayed on the second screen 104, and transmit the first image to the first screen 103 and the second image to the second screen 104.

The first screen 103 may be used to display the first image.

The second screen 104 may be used to display the second image.

In one embodiment, the dual-screen driver chip 102 may include a first interface and two second interfaces.

The first interface may be used to connect to the application processor 101 to receive the image to be displayed transmitted by the application processor 101.

One of the two second interfaces may be connected to the first screen 103 of the video glasses, and the other second interface may be connected to the second screen 104 of the video glasses.

In the present disclosure, the processing manner of the application processor 101 may be similar to the processing manner of the application processor 101 described above and details are not described herein again.

In the present disclosure, the processing manner of the dual-screen driver chip 102 may be similar to that of the dual-screen driver chip 102 described above and will not be described again.

The dual-screen driver chip 102 mentioned above will be described below.

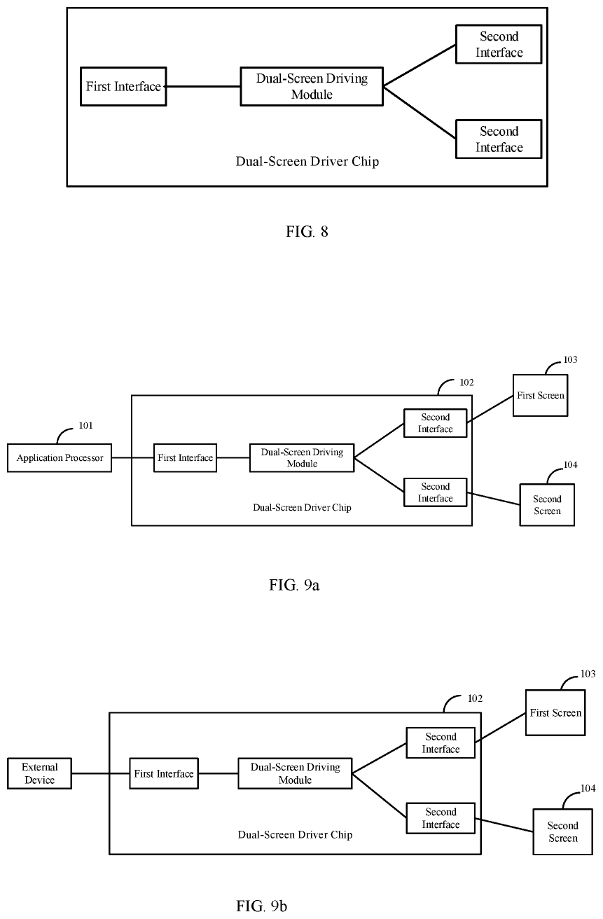

Referring to FIG. 8, which is a schematic diagram of a dual-screen driver chip 102 according to an embodiment of the present disclosure. In the present disclosure, the dual-screen driver chip 102 may include a first interface, two second interfaces, and a dual-screen driving module.

The first interface may be used to receive an image to be displayed.

One of the two second interfaces may be connected to the first screen 103 of the dual-screen display device, and the other second interface may be connected to the second screen 104 of the dual-screen display device.

The dual-screen driving module may be used to perform a dual-screen display processing on the image to be displayed received through the first interface to obtain a first image that may be displayed on the first screen 103 and a second image that may be displayed on the second screen 104, and transmit the first image to the first screen 103 through the second interface connected to the first screen and the second image to the second screen 104 through the second interface connected to the second screen.

In one embodiment of the present disclosure, the interface type of the first interface and the second interface may be the same, for example, both interfaces may be MIPI interfaces.

In one embodiment of the present disclosure, the interface types of the first interface and the second interface may also be different. For example, the second interface may be an MIPI interface, and the first interface may be a LVDS interface, a HDML interface, a Display Port, a USB, and the like.

When the interface type of the first interface is different from the second interface, the dual-screen driver module may need to perform a format conversion on the image to be displayed before performing the dual-screen display processing on the image to be displayed received through the first interface such that the format of the image to be displayed may be converted into a format that may match the interface type of the second interface. For example, the second interface may be an MIPI interface and the first interface may be a LVDS interface, and the dual-screen driving module may perform the format conversion on the image to be displayed before performing the dual-screen display processing on the image to be displayed received through the first interface to convert the format of the image to be displayed (a format that matches the LVDS interface) into a format that may match the interface type of the second interface (a format that matches the MIPI interface). Subsequently, the dual-screen display processing may be performed on the image to be displayed after the format conversion.

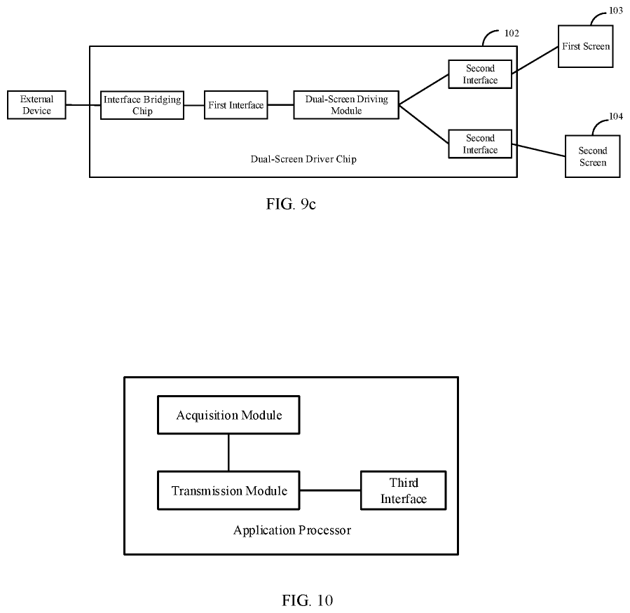

In one embodiment, the first interface may be connected to the application processor 101 of the same device as the dual screen driver chip 102. FIG. 9a is a schematic structural diagram of a dual-screen driver chip 102 connected to an application processor 101 through a first interface according to an embodiment of the present disclosure.

In another embodiment, the first interface may be directly connected to an external device. Correspondingly, the image to be displayed received by the first interface may be derived from the external device. FIG. 9b is a schematic structural diagram of a dual-screen driver chip 102 connected to an external device processor 101 through a first interface according to an embodiment of the present disclosure.

When the first interface is connected to the external device, the following situation may occur: the interface of the first interface may not match the interface of the external device. In this situation, the dual-screen driver chip 102 may need to further include an interface bridging chip. FIG. 9c is a schematic structural diagram of a dual-screen driver chip 102 connected to an external device processor 101 through a first interface and an interface bridging chip according to an embodiment of the present disclosure.

As shown in FIG. 9c, the first interface may be connected to one end of the interface bridge chip, and the other end of the interface bridge chip may be connected to the external device. The interface bridge chip may be used to connect the first interface with the external device when the interface between the first interface and the external device does not match.

In one embodiment of the present disclosure, when the dual-screen driving module is used in a dual-screen display device that supports three-dimensional display, if the first interface receives the screen image corresponding to the first screen and the screen image corresponding to the second screen in sequence, then the received screen image corresponding to the first screen may be used as the first image that may need to be displayed on the first screen, and the received screen image corresponding to the second screen may be used as the second image that may need to be displayed on the second screen. That is, the dual-screen driving module may perform the dual-screen display processing on the image to be displayed received through the first interface to obtain the first image that may need to be displayed on the first screen and the second image that may need to be displayed on the second screen.

In another embodiment of the present disclosure, when the dual-screen driving module is used in a dual-screen display device that supports three-dimensional display, if the image to be displayed received by the first interface is obtained by compressing the image along a specific direction, when the specific direction is determined, the screen image corresponding to the first screen in the received image to be displayed may be upsampled along the determined specific direction to obtain the first image that may need to be displayed on the first screen, and the screen image corresponding to the second screen in the received image to be displayed may be upsampled along the determined specific direction to obtain the second image that may need to be displayed on the second screen. That is, the dual-screen driving module may perform the dual-screen display processing on the image to be displayed received through the first interface to obtain the first image that may need to be displayed on the first screen and the second image that may need to be displayed on the second screen. It should be noted that the upsampling here may be similar to the above description of the upsampling and will not be described again.

In another embodiment of the present disclosure, when the dual-screen driving module is used in a dual-screen display device that supports three-dimensional display, if the image to be displayed received by the first interface is obtained by compressing the image along a specific direction, when the specific direction can not be determined, the screen image corresponding to the first screen in the received image to be displayed may be forcibly upsampled along the positional arrangement direction of the first screen and the second screen to obtain the first image that may need to be displayed on the first screen, and the screen image corresponding to the second screen in the received image to be displayed may be forcibly upsampled along the positional arrangement direction of the first screen and the second screen to obtain the second image that may need to be displayed on the second screen. That is, the dual-screen driving module may perform the dual-screen display processing on the image to be displayed received through the first interface to obtain the first image that may need to be displayed on the first screen and the second image that may need to be displayed on the second screen. It should be noted that the upsampling here may be similar to the above description of the upsampling and will not be described again.

In another embodiment of the present disclosure, when the dual-screen driving module is used in a dual-screen display device that supports two-dimensional display, determining the image to be displayed received through the first interface may respectively include the first image that may need to be displayed on the first screen and the second image that may need to be displayed on the second screen. That is, the dual-screen driving module may perform the dual-screen display processing on the image to be displayed received through the first interface to obtain the first image that may need to be displayed on the first screen and the second image that may need to be displayed on the second screen.

The application processor 101 will be described below.

Referring to FIG. 10, which is a schematic diagram of an application processor 101 according to an embodiment of the present disclosure. In the present disclosure, the application processor 101 may include an acquisition module, a third interface, and a transmission module.

The third interface may be used to connect the dual-screen driver chip 102.

The acquisition module may be used to acquire the image to be displayed.

The transmission module may be used to transmit the image to be displayed acquired by the acquisition module through the third interface.

In one embodiment of the present disclosure, when the dual-screen display device supports three-dimensional display, the transmission module may transmit the screen image corresponding to the first screen and the screen image corresponding to the second screen to the dual-screen driver chip in sequence through the third interface.

In another embodiment of the present disclosure, when the dual-screen display device supports three-dimensional display, the acquisition module may compress the image corresponding to the first screen in the acquired image to be displayed by half along a specific direction to obtain the first screen image, compress the image corresponding to the second screen in the acquired image to be displayed by half along the specific direction to obtain the second screen image, and stitch the first screen image and the second screen image together to obtain a new image to be displayed.

It should be note that, in the present disclosure, the dual-screen driver chip 102 may be further used to control the first screen 103 and the second screen 104 to perform specific processing. More specifically, the purpose of the dual-screen driver chip 102 controlling the first screen 103 and the second screen 104 to perform specific processing may be to improve the image display quality of the first image displayed on the first screen 103 and the second image displayed on the second screen 104 after processing through an optical system. In one embodiment, the specific processing may include a mirror flip or a rotation. Taking the mirror flip as an example, in a normal situation, the first image of the first screen 103 and the second image of the second screen 104 transmitted by the dual-screen driver chip 102 may be respectively reflected through the optical system such as a reflective mirror such that the images of the left and right eyes reflected to the user may be flipped. To ensure the clarity of the image, the dual-screen driver chip 102 may need to control the first screen 103 and the second screen 104 to flip. As such, the first image of the first screen 103 and the second image of the second screen 104 transmitted by the dual-screen driver chip 102 may be respectively reflected by the reflective mirror such that the images of the left and right eyes reflected to the user may be in the correct direction so the user may easily recognize the image. In addition, the principle of the dual-screen driver chip 102 controlling the first screen 103 and the second screen 104 to perform the rotation may be similar to the mirror flip mentioned above, and details are not described herein again.

Based on the dual-screen display device shown in FIG. 1, a corresponding method will be described below.

Referring to FIG. 11, which is a flowchart of a method according to an embodiment of the present disclosure. The method may be applied to a dual-screen display device. In one embodiment, the dual-screen display device may include an application processor, a dual-screen driver chip, a first screen, and a second screen.

As shown in FIG. 11, the method provided in the present disclosure may include the following steps:

Step 1101, the application processor transmits the image to be displayed to the dual-screen driver chip.

Step 1102, the dual-screen driver chip performs a dual-screen display processing on the received image to be displayed to obtain a first image that may need to be displayed on the first screen and a second image that may need to be displayed on the second screen, and transmit the first image to the first screen and the second image to the second screen.

In one embodiment of the present disclosure, when the dual-screen display device supports three-dimensional display, the transmission of the image to be displayed to the dual-screen driver chip in Step 1101 may include: sequentially transmitting the screen image corresponding to the first screen and the screen image corresponding to the second screen to the dual screen driver chip.

Based on the above description, in Step 1102, the dual-screen display processing on the received image to be displayed to obtain the first image that may need to be displayed on the first screen and the second image that may need to be displayed on the second screen may include: using the received screen image corresponding to the first screen as the first image that may need to be displayed on the first screen and the received screen image corresponding to the second screen as the second image that may need to be displayed on the second screen in response to receiving the screen image corresponding to the first screen and the screen image corresponding to the second screen in sequence.

In one embodiment of the present disclosure, when the dual-screen display device supports three-dimensional display, the transmission of the image to be displayed to the dual-screen driver chip in Step 1101 may include:

When the dual-screen display device supports three-dimensional display, compressing the screen image corresponding to the first screen in the image to be displayed by half along a specific direction to obtain the first image, and compressing the screen image corresponding to the second screen in the image to be displayed by half along the specific direction to obtain the second image; and transmitting an image obtained by stitching the first screen image and the second screen image together as a new image to be displayed to the dual-screen driver chip. In particular, the specific direction may be a horizontal direction or a vertical direction.

Based on the above description, when the dual-screen driver chip is able to determine the specific direction mentioned above, in Step 1102, the dual-screen display processing on the received image to be displayed to obtain the first image that may need to be displayed on the first screen and the second image that may need to be displayed on the second screen may include: upsampling the first screen image in the image to be displayed along the determined specific direction to obtain the first image that may need to be displayed on the first screen and upsampling the second screen image in the image to be displayed along the determined specific direction to obtain the second image that may need to be displayed on the second screen.

Further, the image to be displayed may carry an identifier of specific direction. As such, the dual-screen driver chip may determine the specific direction based on the identifier of the specific direction carried by the image to be displayed.

When the dual-screen driver chip is unable to determine the specific direction mentioned above, in Step 1102, the dual-screen display processing on the received image to be displayed to obtain the first image that may need to be displayed on the first screen and the second image that may need to be displayed on the second screen may include: forcibly upsampling the screen image corresponding to the first screen in the received image to be displayed along the positional arrangement direction of the first screen and the second screen to obtain the first image that may need to be displayed on the first screen, and forcibly upsampling the screen image corresponding to the second screen in the received image to be displayed along the positional arrangement direction of the first screen and the second screen to obtain the second image that may need to be displayed on the second screen.

In one embodiment of the present disclosure, when the dual-screen display device supports two-dimensional display, in Step 1102, the dual-screen display processing on the received image to be displayed to obtain the first image that may need to be displayed on the first screen and the second image that may need to be displayed on the second screen may include:

When the dual-screen display device supports two-dimensional display, the received image to be displayed may be respectively used as the first image to be displayed on the first screen and the second image to be displayed on the second screen.

In addition, in the present disclosure, the dual-screen driver chip may further control the first screen and the second screen to perform specific processing based on requirements. The specific processing may include a mirror flip or a rotation.

At the point, the description of the method shown in FIG. 11 is completed.

Correspondingly, the present disclosure also provides an apparatus corresponding to the method shown in FIG. 11.

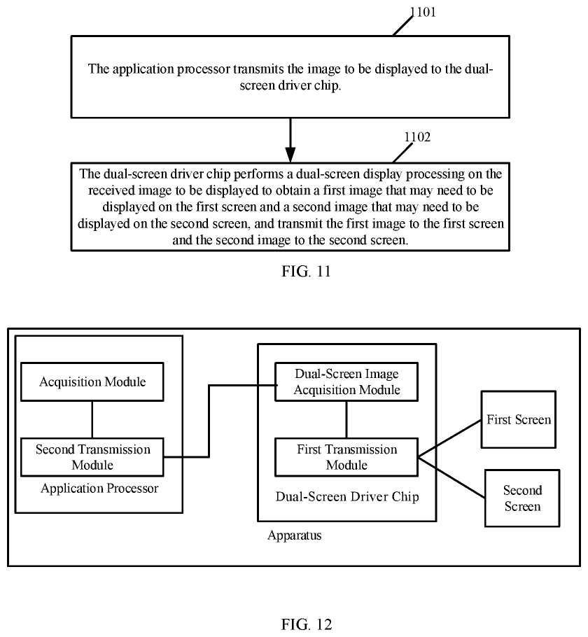

Referring to FIG. 12, which is a structural view of a device according to an embodiment of the present disclosure. The apparatus may be applied to a dual-screen display device, and the dual-screen display device may include an application processor, a dual-screen driver chip, a first screen, and a second screen.

As shown in FIG. 12, the apparatus may include:

An acquisition module that may be disposed in the application processor to acquire an image to be displayed.

A second transmission module that may be disposed in the application processor to transmit the image to be displayed to the dual-screen driver chip.

A dual-screen image acquisition module that may be disposed in the dual-screen driver chip to perform a dual-screen display processing on the received image to be displayed to obtain a first image that may need to be displayed on the first screen, and a second screen that may need to be displayed on the second screen.

A first transmission module that may be disposed in the dual-screen driver chip to transmit the first image to the first screen and the second image to the second screen.

In one embodiment, when the dual-screen display device supports three-dimensional display, the second transmission module may transmit the screen image corresponding to the first screen and the screen image corresponding to the second screen to the dual-screen driver chip in sequence.

After the dual-screen image acquisition module receives the screen image corresponding to the first screen and the screen image corresponding to the second screen in sequence, the dual-screen image acquisition module may use the received screen image corresponding to the first screen as the first image that may need to be displayed on the first screen, and the received screen image corresponding to the second screen as the second image that may need to be displayed on the second screen.

When the dual-screen display device supports three-dimensional display, the acquisition module may compress the screen image corresponding to the first screen in the image to be displayed by half along a specific direction to obtain the first image, compress the screen image corresponding to the second screen in the image to be displayed by half along the specific direction to obtain the second image; and determine a new image obtained by stitching the first screen image and the second screen image together as a new image to be displayed.

The second transmission module may transmit the new image to be displayed determined by the acquisition module to the dual-screen driver chip.

When the dual-screen image acquisition module is able to determine the specific direction, the dual-screen image acquisition module may perform upsampling the first screen image in the image to be displayed along the determined specific direction to obtain the first image that may need to be displayed on the first screen, and upsampling the second screen image in the image to be displayed along the determined specific direction to obtain the second image that may need to be displayed on the second screen.

In one embodiment, the image to be displayed may carry an identifier of the specific direction and the dual-screen image acquisition module may determine the specific direction based on the identifier of the specific direction carried by the image to be displayed

In particular, the specific direction may be a horizontal direction or a vertical direction.

In the present disclosure, if the dual-screen image acquisition module is unable to determine specific direction, the dual-screen image acquisition module may forcibly upsample the screen image corresponding to the first screen in the received image to be displayed along the positional arrangement direction of the first screen and the second screen to obtain the first image that may need to be displayed on the first screen, and forcibly upsample the screen image corresponding to the second screen in the received image to be displayed along the positional arrangement direction of the first screen and the second screen to obtain the second image that may need to be displayed on the second screen.

In the present disclosure, when the dual-screen display device supports two-dimensional display, the dual-screen image acquisition module may use the received image to be displayed as the first image that may need to be displayed on the first screen and the second image that may need to be displayed on the second screen.

It should be noted that the foregoing embodiments are some of the embodiments of the present disclosure and should not be used to limit the present disclosure. Any modification, equivalent substitution, improvement within the spirit and principle of the present disclosure should be covered in the protection scope of the present disclosure.

What is claimed is:

1. A pair of video glasses, comprising:
a body, and an application processor, a dual-screen driver chip, a first screen, and a second screen carried on the body;
wherein the application processor transmits an image to be displayed to the dual-screen driver chip;
the dual-screen driver chip performs a dual-screen display processing on the received image to be displayed to obtain a first image to be displayed on the first screen and a second image to be displayed on the second screen, and transmits the first image to the first screen and the second image to the second screen;
the first screen displays the first image; and,
the second screen displays the second image.

2. The video glasses of claim 1, wherein the dual-screen driver chip includes a first interface and two second interfaces;
the first interface connects to the application processor to receive the image to be displayed transmitted by the application processor; and,
one of the two second interfaces is connected to the first screen, and the other second interfaces is connected to the second screen.

3. The video glasses of claim 2, wherein when the video glasses support three-dimensional displays, the application processor transmits an screen image in the image to be displayed corresponding to the first screen and the screen image in the image to be displayed corresponding to the second screen to the dual-screen driver chip in sequence.

4. The video glasses of claim 3, wherein the dual-screen driver chip uses the received screen image corresponding to the first screen as the first image to be displayed on the first screen, and the received screen image corresponding to the second screen as the second image to be displayed on the second screen in response to receiving the screen image corresponding to the first screen and the screen image corresponding to the second screen through the first interface.

5. The video glasses of claim 2, wherein when the video glasses support three-dimensional display, the application processor compresses the screen image corresponding to the first screen in the image to be displayed by half along a specific direction to obtain the first screen image, compress the screen image corresponding to the second screen in the image to be displayed by half along the specific direction to obtain the second screen image, and transmit an image obtained by stitching the first screen image and second screen image together as the image to be displayed to the dual-screen driver chip.

6. The video glasses of claim 5, wherein the dual-screen driver chip determines the specific direction to perform upsampling on the first screen image in the image to be displayed along the specific direction to obtain the first image to be displayed on the first screen, and perform upsampling on the second screen image in the image to be displayed along the specific direction to obtain the second image to be displayed on the second screen.

7. The video glasses of claim 5, wherein the specific direction is a horizontal direction or a vertical direction.

8. The video glasses of claim 5, wherein the image to be displayed carries an identifier of the specific direction and the dual-screen driver chip determines the specific direction based on the identifier of the specific direction carried by the image to be displayed.

9. The video glasses of claim 5, wherein when the specific direction is undetermined, the dual-screen driver chip performs upsampling on the first screen image in the image to be displayed along a positional arrangement direction of the first screen and the second screen to obtain the first image to be displayed on the first screen, and performs upsampling on the second screen image in the image to be displayed along the positional arrangement direction of the first screen and the second screen to obtain the second image to be displayed on the second screen.

10. The video glasses of claim 1, wherein when the video glasses support two-dimensional display, the dual-screen driver chip uses the received image to be displayed as the first image to be displayed on the first screen and the second image to be displayed on the second screen.

11. A dual-screen driver chip, comprising:
a first interface, two second interfaces, and a dual-screen driving module;
wherein the first interface receives an image to be displayed;
one of the two second interfaces is connected to a first screen of a dual-screen display device, and the other second interfaces is connected to a second screen of the dual-screen display device; and,
the dual-screen driving module performs a dual-screen display processing on the image to be displayed received through the first interface to obtain a first image to be displayed on the first screen and a second image to be displayed on the second screen, and transmit the first image to the first screen through the second interface connected to the first screen and the second image to the second screen through the second interface connected to the second screen.

12. The chip of claim 11, wherein the first interface is connected to an application processor or the first interface is connected to an external device.

13. The chip of claim 11, further comprising:
an interface bridging chip;
wherein the first interface is connected to one end of the interface bridging chip, the other end of the interface bridging chip is connected to an external device, and the interface bridging chip connects the first interface with the external device when an interface of the first interface does not match an interface of the external device.

14. The chip of claim 11, wherein when the dual-screen driving module supports three-dimensional display, the dual-screen driving module uses the received screen image corresponding to the first screen as the first image to be displayed on the first screen, and the received screen image corresponding to the second screen as the second image to be displayed on the second screen in response to receiving the screen image corresponding to the first screen and the screen image corresponding to the second screen in the image to be displayed in sequence through the first interface.

15. The chip of claim 11, wherein when the dual-screen driving module supports three-dimensional display, if the image to be displayed received through the first interface is compressed along a specific direction, the dual-screen driving module performs upsampling on the first screen image in the image to be displayed along the determined specific direction to obtain the first image to be displayed on the first screen, and perform upsampling on the second screen image in the image to be displayed along the determined specific direction to obtain the second image to be displayed on the second screen.

16. The chip of claim 11, wherein when the dual-screen driving module supports three-dimensional display, if the image to be displayed received through the first interface is compressed along a specific direction, when the specific direction is undetermined, the dual-screen driving module performs upsampling on the first screen image in the image to be displayed along a positional arrangement direction of the first screen and the second screen to obtain the first image to be displayed on the first screen, and perform upsampling on the second screen image in the image to be displayed along the positional arrangement direction of the first screen and the second screen to obtain the second image to be displayed on the second screen, or wherein when the dual-screen driving module supports two-dimensional display, the dual-screen driving module determines the image received through the first interface is the first image to be displayed on the first screen and the second image to be displayed on the second screen.

17. The chip of claim 11, wherein an interface type of the first interface is different from the interface type of the second interface; and,
before performing the dual-screen display processing on the image to be displayed received through the first interface, the dual-screen driving module further converts an image format of the image to be displayed received through the first interface into the image format supported by the interface type of the second interface, and performs the dual-screen display processing on the formatted image to be displayed to obtain the first image to be displayed on the first screen and the second image to be displayed on the second screen.

18. A processor, comprising:
an interface, an acquisition module, and a transmission module;
wherein the interface is connected to a dual-screen driver chip;
the acquisition module acquires an image to be displayed;
the transmission module unicasts the image to be displayed acquired by the acquisition module by using the interface.

19. The processor of claim 18, wherein the transmission module is further configured to transmit a screen image corresponding to a first screen and the screen image corresponding to a second screen to the dual-screen driver chip in sequence through the interface.

20. The processor of claim 19, wherein the acquisition module is configured compress the screen image corresponding to the first screen in the acquired image to be displayed by half along a specific direction to obtain a first screen image, compress the screen image corresponding to the second screen in the acquired image to be displayed by half along the specific direction to obtain a second screen image, and use the image obtained by stitching the first screen image and the second screen image together as a new image to be displayed.
